(19) United States
(12) Patent Application Publication
(10) Pub. No.: US 2025/0002308 A1
(43) Pub. Date: Jan. 2, 2025

(54) LOAD TRANSFER RIGGING DEVICE AND METHOD FOR MOUNTING APPURTENANCES

(71) Applicant: Murphy Tower Service, LLC, Carlisle, IA (US)

(72) Inventor: Daniel Rodriguez, Oskaloosa, IA (US)

(73) Assignee: Murphy Tower Service, LLC, Carlisle, IA (US)

(21) Appl. No.: 18/758,427

(22) Filed: Jun. 28, 2024

Related U.S. Application Data
(60) Provisional application No. 63/524,008, filed on Jun. 29, 2023.

(51) Int. Cl. B66D 1/42

(52) U.S. Cl. CPC B66D 1/42

(57) ABSTRACT

The present invention is a load transfer device and method of use comprising a pulley system attached to a universal pipe mount with a rope retention device. The load transfer device of the present invention allows for the maneuvering of appurtenances, such as antennas or other equipment from a load line rigged to a the main structure of a vertical infrastructure installation, to a desired installation location, such as on a standoff mount. The load transfer device helps to suspend the equipment or antenna in place above the desired installation location, enabling operators to use both hands to install the appurtenance.

### CROSS REFERENCE TO RELATED APPLICATIONS

This application claims priority from U.S. Provisional Application Ser. No. 63/524,008 filed Jun. 29, 2023, and entitled LOAD TRANSFER RIGGING DEVICE FOR MOUNTING COMPONENTS TO A TOWER. The contents of U.S. Provisional Application Ser. No. 63/524,008 are hereby incorporated in their entirety by reference.

### FIELD OF THE INVENTION

This invention relates generally to a device and method of using same for moving objects between the top of a vertical infrastructure installation, such as a mast or tower, and a peripheral installation location on the installation structure. Such towers include, but are not limited to, broadcast and cell towers.

### BACKGROUND

Towers, including but not limited to broadcast and cell towers, are in place to hold and support appurtenances at great heights. Such appurtenances may include, but are not limited to, one or more antennas, as well as supporting equipment such as transceivers, baseband units, and/or power sources. Towers can be self-supporting structures, or they may include guyed wires to keep them erect. As used in this application, the term mast is used to refer to any pipe mount used to attach appurtenances, and may be located on a vertical installation structure or on the ground. Antennas may be made up of several different components, which individually have the potential to be heavy and/or large, causing them to be generally unwieldy. Accordingly, the complete antenna is typically also quite heavy and large. In some instances, these complete antennas can weigh up to 200 pounds and vary between 6-20 feet in length. Additionally, after the installation, antennas and/or the components thereof must be serviced and/or replaced from time to time. This work is dangerous, as it requires climbing to tall heights, typically at or near the very top of a tower and working with heavy equipment.

The weight of appurtenances, such as antennas, transceivers, baseband units, power sources, and/or other equipment has increased over time, with the trend potentially continuing. Crews for servicing towers can sometimes consist of only two operators working together to perform the service. In these arrangements, one operator remains on the ground while the other operator is on the tower. When servicing a tower, sometimes the service must occur at the top of the tower. For these types of services, this will mean that there is no structure above the location of service. Accordingly, an operator performing the service would be unable to attach a load line directly above the location of the service to aid in the installation or removal of equipment mounted to the location of service. Various types of equipment, such as antennas, are generally installed on a peripheral location, such as a standoff mount, in some instances referred to as peripheral antenna mount, some distance from the main structure. However, these mounts are not rated to handle the forces that would result from lifting equipment from the ground to the installation location on the standoff mount via a lifting system attached to the standoff mount. Accordingly, the antenna or other equipment would be raised to the appropriate height via a pulley system or “load line” that is attached to the main structure of the tower. Typically, there is not a structure immediately above an antenna mount to attach ropes to for lowering and/or raising antennas or components thereof. In the prior art, an operator would use a load line attached to the main structure to raise the equipment to an appropriate height. However, after the equipment was raised, the operator would have to fight and support a large portion of the weight of the antenna in order to maneuver it over to the desired installation location. The combination of the weight of the equipment and the position that operators would need to assume to move the equipment has the potential to put a large degree of torque and strain on the operator's back. The repeated strain caused by servicing such equipment carries a risk of developing undesirable musculoskeletal injuries.

Needed is a load transfer device designed to support the weight of components at the top of a tower and/or top of an antenna mount where there is no tower or other structure directly above the component to support the weight of the component during service. Sometimes operators servicing such a set-up can rig a load line above their desired location of installation to aid in installation. However, that is not possible at the top of the tower or when working on an antenna mount. There are many rigging standards in the industry due to the many inherent dangers with regards to rigging. These standards include ANSI Standard A10.48, which relates to work practices on telecommunications towers, as well as ANSI/TIA-322, which relates to loading, analysis, and design criteria for the installation, alteration, and maintenance of communication structures. There are many factors that add to the complexity of rigging telecommunications equipment. For instance, towers, such as cell towers, typically range from 50 to 200 feet in height, the weight of equipment is significant, and the location on the tower where the rigging is to be performed is less than favorable. Accordingly, it is unsafe and typically illegal to attach a pulley and/or rope to a mount at the very top of a tower.

Pulley systems, also known as rope and pulley systems or block and tackle systems are traditional means known in the art to lift or move a load. Pulley systems are characterized by the use of a single continuous rope or line assembled with one or more pulley wheels to provide a mechanical advantage to apply larger forces.

There are devices that have been previously used, such as “Rooster Heads” that are not allowed on many sites. These devices are not allowed because they apply external rigging forces to the peripheral antenna mounts, where the equipment is to be mounted. As stated above, these peripheral mounts are not rated for those kinds of external rigging forces, and using Rooster Heads in that fashion can greatly increase the risk of catastrophic failure of the antenna mounts. Even in locations where they are permitted, “Rooster heads” will typically require prior engineer sign off, and will need to be connected to the main tower structure via additional support lines. Currently there are no devices that are load rated or meant to be used in the ends of antenna pipes for rigging purposes that adhere to the standards, that do not apply external rigging forces to the standoff mounts. As stated above, methods and devices of the prior art apply external rigging forces to the standoff mounts. This puts pressure on the antenna pipe which can lead to catastrophic failure of the standoff mount, which is unsafe. However, the load transfer device of the present invention is a stand-alone device, meaning that it does not require a supporting connection to the main structure to operate, and does not apply external rigging forces. When using the load transfer device of this invention, the only force on the antenna pipe is the weight of the antenna.

### SUMMARY

In order to avoid undesirable musculoskeletal injuries while also adhering to industry standards, a load transfer device is provided. In some embodiments, the device comprises a 2:1 pulley system attached to a universal pipe mount with a rope retention device. The load transfer device may also include an elongated member configured to connect to a vertical infrastructure installation, such as a tower, a head which includes a housing and a first pulley wheel, a pulley rope in communication with the head, a second pulley wheel in communication with the pulley rope, as well as a clasping device, such as a slip hook attached to the second pulley wheel.

The load transfer device of the present invention allows an operator to pull appurtenances, such as antennas or other equipment from a load line rigged to the main structure, to a desired installation location, such as on a standoff mount, and suspend the equipment or antenna in place above the desired installation location. An operator may then mount it using both hands freely. Using the load transfer device will not add any more weight or rigging forces to the gate. Further, it will decrease the load force stress on the operator by half, with the use of a 2:1 pulley system. Having the capability to place the weight of the equipment or antenna onto the load transfer device of the present invention allows an operator to perform these tasks without risk of back injury or other musculoskeletal injuries.

### BRIEF DESCRIPTION OF THE DRAWINGS

FIG. 1. is a perspective view of an embodiment of a load transfer device of the present invention.

FIG. 2 is an elevation view of the embodiment of the load transfer device of FIG. 1.

FIG. 3 is an enlarged sectional view of a portion of the embodiment of the load transfer device of FIG. 1.

FIG. 4 is an elevation view of the load transfer device being placed in an antenna mount.

FIG. 5 is an elevation view of the load transfer device placed in an antenna mount and ready for use.

FIG. 6 is an elevation view of the load transfer device showing an antenna being raised to the level of the load transfer device.

FIG. 7 is an elevation view of the load transfer device showing an antenna attached to the load transfer device.

FIG. 8 is an elevation view of the load transfer device of the present invention showing an antenna attached to the load transfer device shifted towards the load transfer device.

FIG. 9 is an elevation of the load transfer device of the present invention showing an antenna attached to the load transfer device and shifted to a desired installation location.

FIG. 10 is an elevation view of the load transfer device being removed after the installation of an antenna.

### DETAILED DESCRIPTION

Example embodiments will now be described more fully with reference to the accompanying drawings. Example embodiments are provided so that this disclosure will fully convey the scope of the mechanism and operation to one having at least ordinary skill in the art. Numerous specific details are set forth such as examples of specific components, devices, and methods, to provide a thorough understanding of embodiments of the present disclosure. It will be apparent to one having at least ordinary skill in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The following is a detailed description of an embodiment of a load transfer rigging device for mounting appurtenances to a vertical infrastructure installation, such as a tower or a mast. Disclosed are novel devices and methods. Such technology and methods may be used in association with any type of vertical infrastructure installation or appurtenances to be transported between an installation and the ground or another elevation in between. For ease of discussion and understanding, the following detailed description may refer to the invention for use with cell or broadcast towers and with respect to transporting antennas, components of antennas, and/or tools for servicing antennas. However, it should be appreciated that the technology and methods may be used with any type of appropriate vertical infrastructure installation, including towers and/or masts to transport any type of load, including but not limited to telecommunications equipment such as antennas, transceivers, baseband units, and/or power sources. Other types of loads may include Grip Strut® safety grating (catwalk) that is used to form a protective canopy or icebridge between the main structure of a tower and a shelter or enclosure some distance away. Additionally, while the towers and/or masts have been described as cell or broadcast towers, the technology and methods may be used with any appropriate structure, including but not limited to broadcast towers, radar towers, weather towers, electric transmission towers, government towers, or military towers.

The invention is for use by one or more operators who are working on a telecommunications structure, and most particularly when the one or more operator(s) is at the top of the structure and there is nothing above them. The load transfer device of the present invention includes a pulley. In some embodiments, the pulley has a 2:1 ratio to decrease the force required by the operator performing the service; however, any ratio may be used without departing from the scope of the invention.

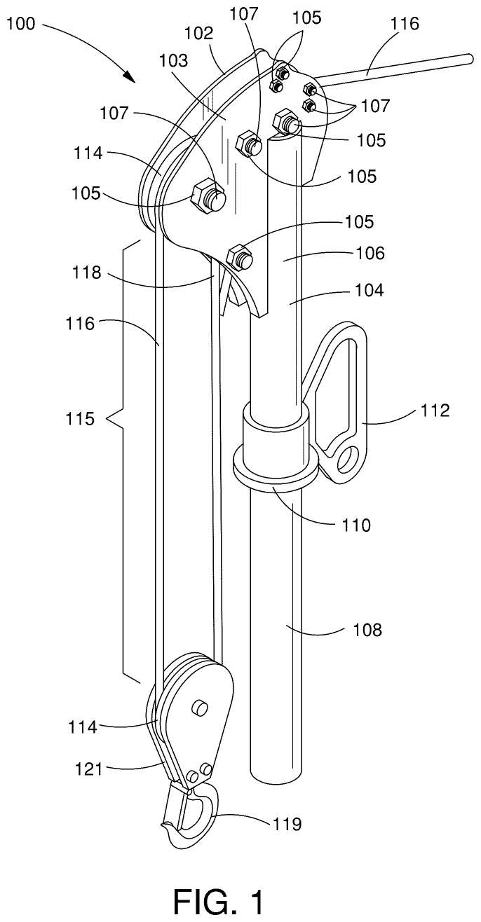

Shown in FIG. 1 is one embodiment of a load transfer device 100 of the present invention. The load transfer 100 device generally includes a head 102 and an elongated member 104. The elongated member 104 further comprises a first end 106 and a second end 108. In some embodiments, the elongated member 104 further comprises a collar 110 located between the first end 106 and the second end 108. In the shown embodiment, the head 102 of the load transfer device 100 comprises two flat plates 103 connected to each other by nuts 105 and bolts 107. However, other attachment mechanisms, such as rivets, may be used without departing from the scope of the invention. The head 102 of the load transfer device 100 shown in FIG. 1 is fixed to the first end 106 of the elongated member 104. In the preferred embodiment, the head 102 is fixed to the elongated member 104 by a permanent attachment means, such as by welding. However, other attachment means such as brazing, soldering, riveting, adhesive bonding, or mechanical fastening may be used without departing from the scope of the invention. In some embodiments of the invention, the collar 110 further includes a handle 112 for easier handling of the load transfer device 100.

The head 102 of the load transfer device 100 further includes one or more pulley wheels 114 in communication with the head 102. The pulley wheels 114 may be directly attached to the head 102, or they may be in communication with the head 102 by means of one or more pulley ropes 116. The pulley wheels 114 may further includes a clasping device 121 to attach to an antenna 144. In one embodiment, the clasping device 121 is a slip hook 119 fixed to a pulley wheel 114. However, other types of clasping devices 121 may be used, such as a snap hook, grab hook, or S-hook without departing from the scope of the invention. Also shown is a pulley rope attachment point 118 where one end of the pulley rope 116 is attached to the head 102.

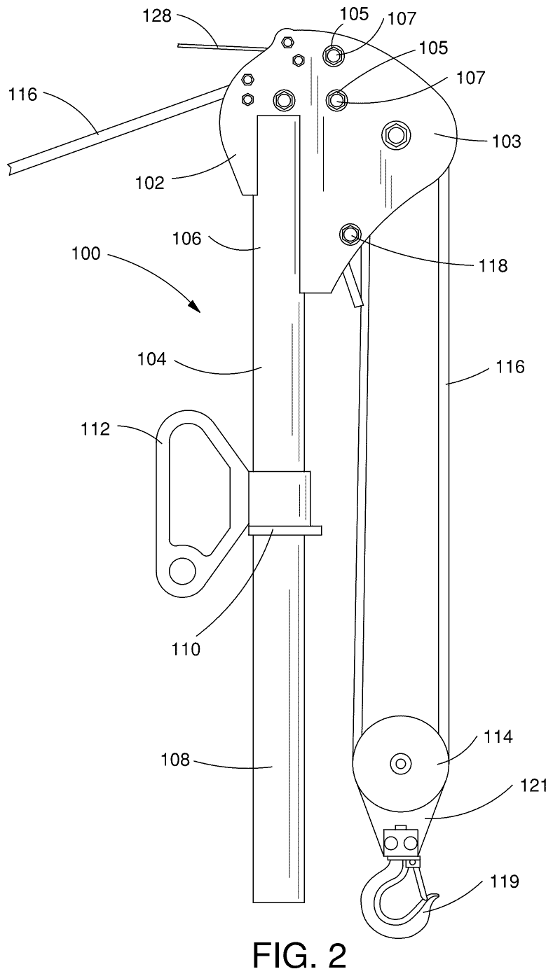

Shown in FIG. 2 is an elevation view of one embodiment of a load transfer device 100 of the present invention. The load transfer device 100 generally includes a head 102 and an elongated member 104 attached to said head 102. The elongated member 104 further comprises a first end 106 and a second end 108. In some embodiments, the elongated member 104 further comprises a collar 110 located between the first end 106 and the second end 108. In the shown embodiment, the head 102 of the load transfer device 100 comprises two flat plates 103 connected to each other by nuts 105 and bolts 107. However, other attachment mechanisms, such as rivets, may be used without departing from the scope of the invention. The head 102 of the load transfer device 100 shown in FIG. 2 is fixed to the first end 106 of the elongated member 104. In some embodiments of the invention, the collar 110 further includes a handle 112 for easier handling of the load transfer device 100.

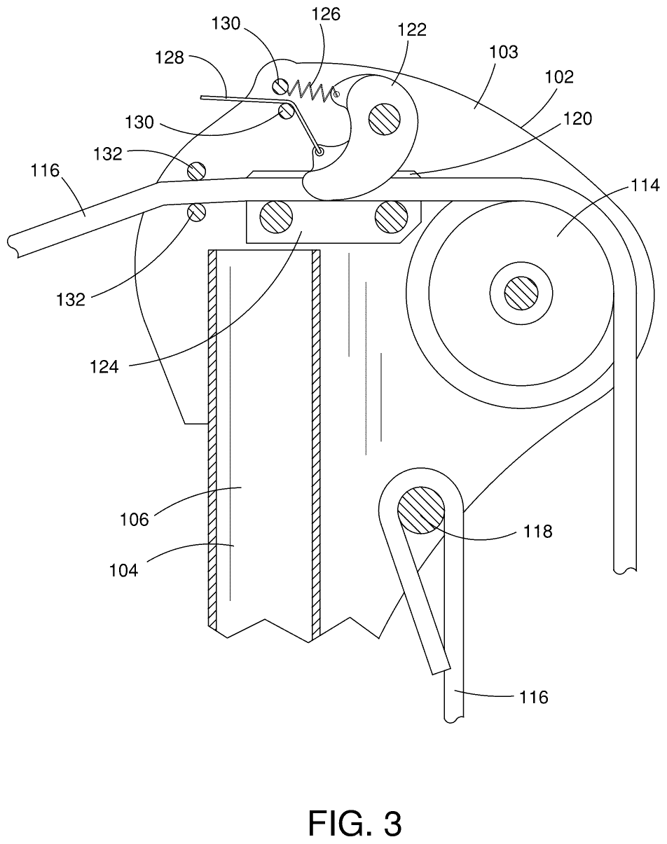

The head 102 of the load transfer device 100 further includes one or more pulley wheels 114 in communication with the head 102. The pulley wheels 114 may be directly attached to the head 102, or they may be in communication with the head 102 by means of one or more pulley ropes 116. The pulley wheels 114 may further includes a clasping device 121 to attach to an antenna 144. In the shown embodiment, the clasping device 121 is a slip hook 119 fixed to the pulley wheels 114. However, other types of clasping devices 121 may be used, such as a snap hook, grab hook, or S-hook without departing from the scope of the invention. Also shown in FIG. 2 is a pull wire 128. The pull wire 128 is connected to a rope retention device 120 (shown best in FIG. 3.)

Shown in FIG. 3 is an enlarged sectional view of the load transfer device 100 of the present invention. A plan view of the head 102 is shown containing a pulley wheel 114. Also shown is a pulley rope 116. The pulley rope 116 is shown attached at one end to the pulley rope attachment point 118. Also shown is a rope retention device 120 of the present invention. In the shown embodiment, the rope retention device 120 comprises a rope grabbing mechanism 122 or camlock and a pressure block 124. When in use, the rope grabbing mechanism 122 exerts pressure on the pulley rope 116 to press the pulley rope 116 into the pressure block 124. This force prevents the pulley rope 116 from moving while the robe grabber 122 is engaged. The rope grabbing mechanism 122 further includes a tension spring 126 to maintain the position of the rope grabbing mechanism 122. The rope grabbing mechanism 122 further includes a pull wire 128 to release the pulley rope 116 from the rope grabbing mechanism 122 by pulling on the bottom of the rope grabbing mechanism 122, displacing the tension spring 126. When the pull wire 128 is released, the displaced tension spring 126 will compress, returning the rope grabbing mechanism 122 to a neutral position. Also shown are wire guards 130 to protect the pull wire 128 from damage. In other embodiments, the rope retention device 120 may comprise a self-capturing knot in conjunction with one or more projections on the elongated member 104 of the load transfer device 100, such as a handle 122.

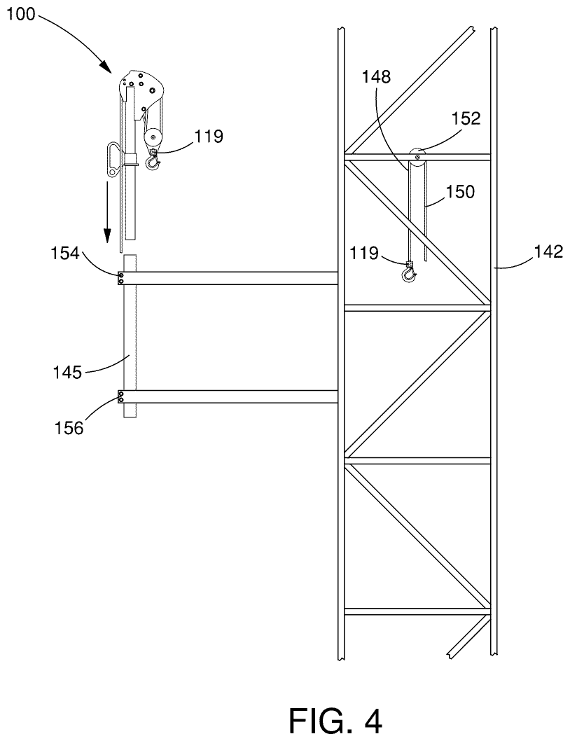

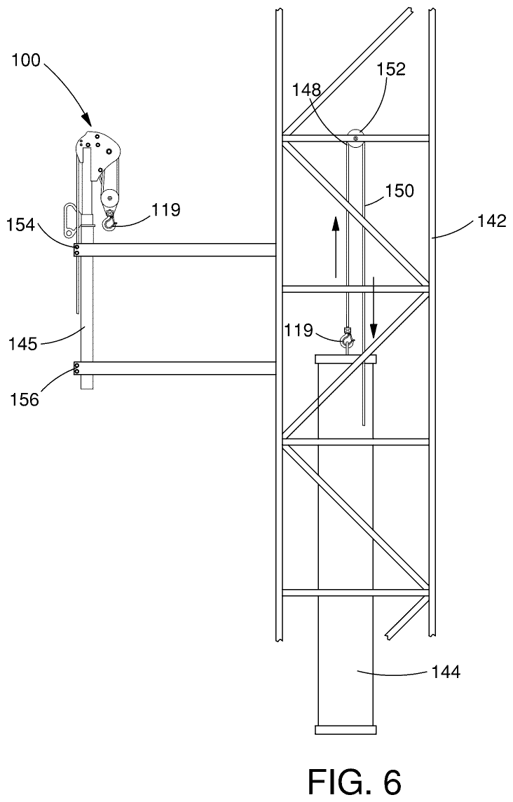

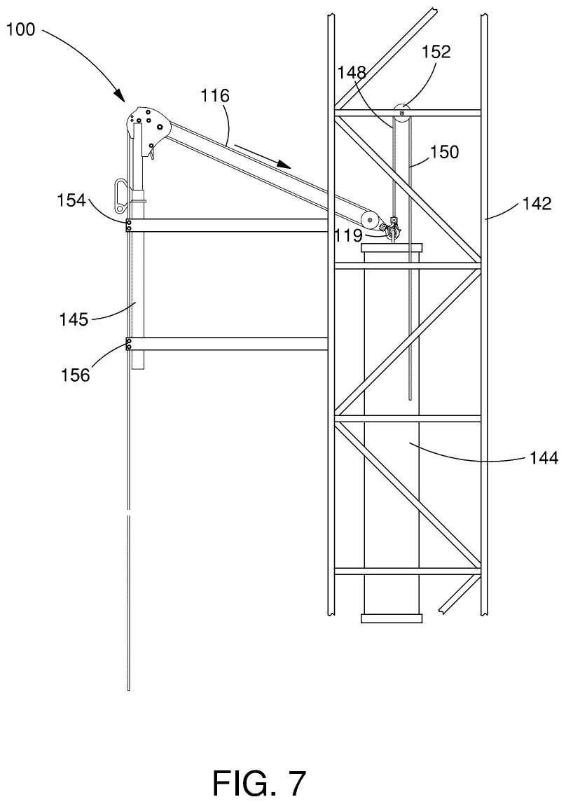

FIGS. 4-10 illustrate the use of a load transfer device 100 of the present invention to aid in the installation of large antennas 144 or other components to a tower 142. The described embodiment will discuss methods for the installation of an antenna 144, but the invention may be used for any service requiring the transport of equipment 146 up and/or down from the top of a tower 142. Typically, an operator will ascend the tower 142 manually with a load line rope 150 and load line pulley 152 in tow that can be used to pull tools and other necessities up the tower 142. The load line rope 150 and load line pulley 152 would be attached to the main structure 151 of the tower 142 and then used as is known in the art to send the load line rope 150 down to retrieve the necessary tools. The load line 148 would also be used to retrieve the load transfer device 100 of the present invention. Shown in FIG. 4 is the installation of the load transfer device 100 into an antenna pipe 145 located in close proximity above a desired installation location 154 as shown in FIG. 4. In the preferred embodiment, the second end 108 of the elongated member 104 is of a size and shape to fit within an antenna pipe 145 on a tower 142. Also shown is a load line 148 which would be used to raise an antenna 144 or other equipment 146 to the height of the desired installation location 154 on the tower 142, seen best in FIGS. 6-7. Also shown is the slip hook 119 of the load transfer device 100.

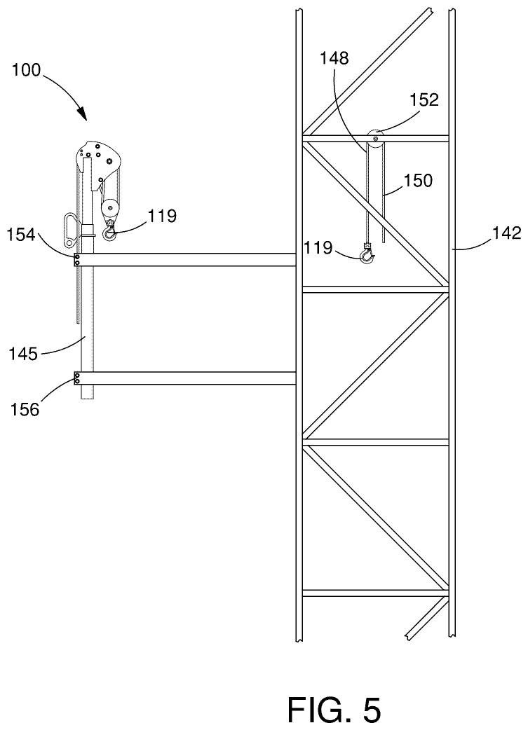

Shown in FIG. 5 is an elevation view of an embodiment of the load transfer device 100 of the present invention after it has been installed in an antenna pipe 145. The load transfer device 100 is shown located in close proximity above the desired installation location 154 on the tower 142. A load line 148 is shown attached to the tower 142. The load line 148 includes a load line rope 150 in communication with a load line pulley 152.

Moving to FIG. 6, an antenna 144 is being raised to the height of the installation location 154 on the tower 142 by the load line 148. The rope 150 of the load line 148 is connected to the antenna 144 by a slip hook 119. The load transfer device 100 of the present invention is shown installed into a peripheral antenna pipe 145 located in close proximity to the desired installation location 154.

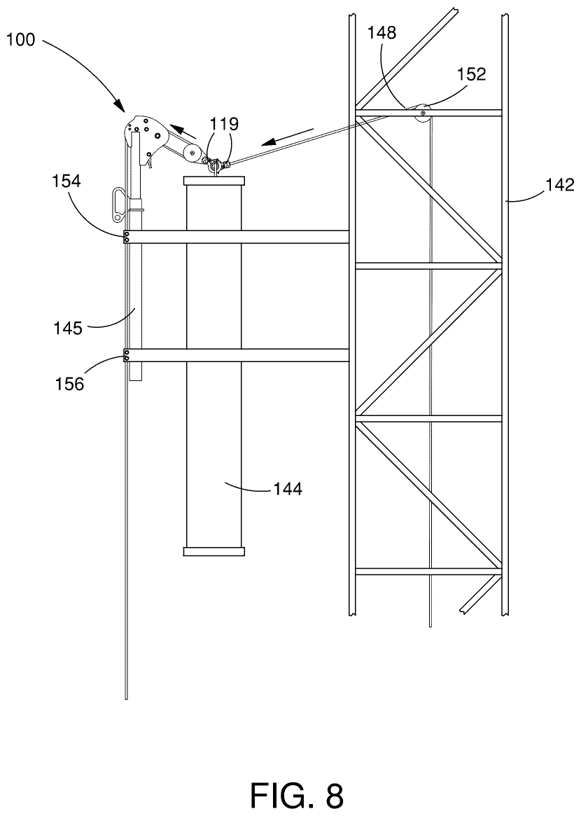

Moving now to FIG. 7, the slip hook 119 of the load transfer device 100 is attached to an antenna 144 while the antenna 144 is suspended from the load line 148. The load line 148 is connected to the main structure of the tower 142. After the slip hook 119 is connected to the antenna 144, the weight of the antenna 144 is slowly shifted from the load line 148 to the load transfer device 100 as seen in FIG. 8. The antenna 144 may be removed from the load line 148 at any time after it is connected to the load transfer device 100. The antenna 144 will preferably be removed from the load line 148 only after a majority of the weight of the antenna 144 is supported by the load transfer device 100.

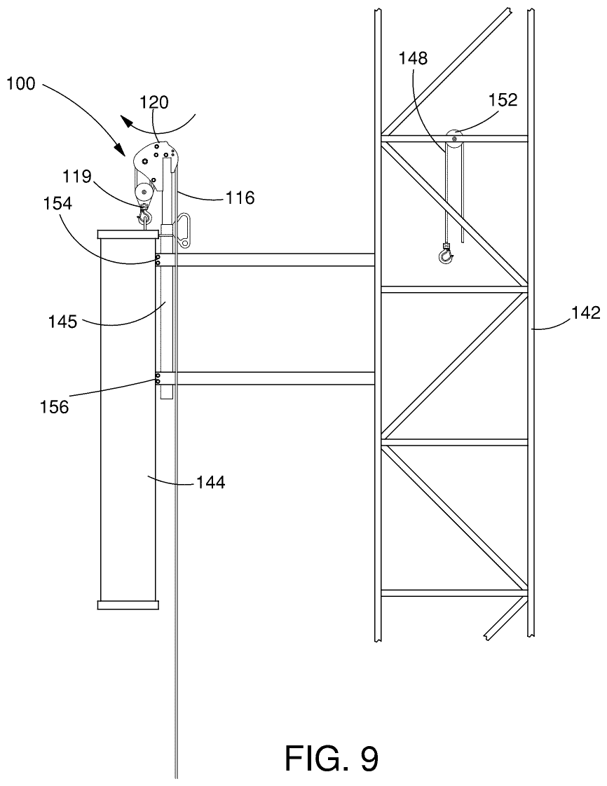

Shown in FIG. 9 is an elevation view of the device of the present invention where the antenna 144 is completely suspended from the load transfer device 100 and attached to the slip hook 119 of the load transfer device 100. In this figure, the antenna 144 has been positioned at a desired installation location 154 on the tower 142. At this point, an operator could easily attach the antenna 144 to the antenna mount 156 without needing to support the weight of the antenna 144. After the antenna 144 is supported by the load transfer device 100, it is easily maneuvered to the desired installation location 154 and fixed to the antenna mount 156. After the antenna 144 is positioned in the desired installation location 154 the rope retention device 120 will retain the position of the antenna 144 without requiring an operator to continue to pull on the pulley rope 116. An operator performing the service would then have two free hands to mount the antenna 144 into the desired installation location 154. Having the capability to place the weight of the antenna 144 onto the load transfer device 100 allows the operator to perform these tasks without risk of back injury, shoulder or other musculoskeletal injuries.

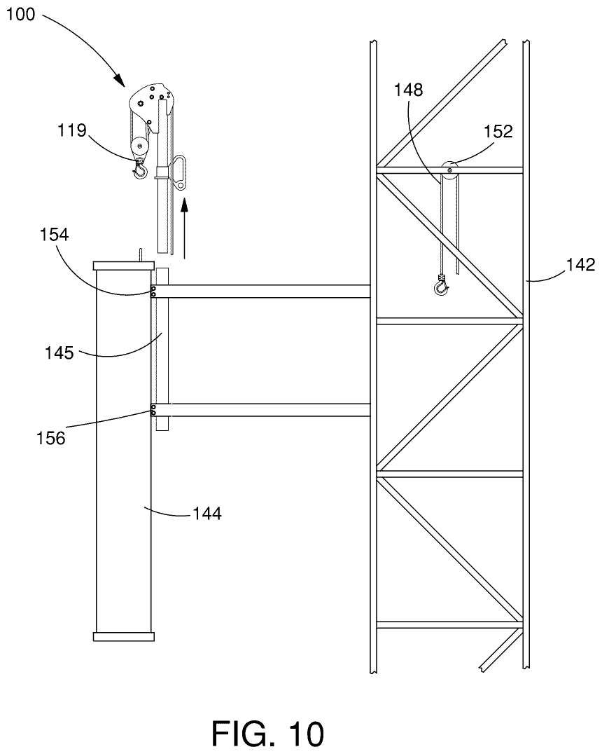

After the antenna 144 has been installed in the desired installation location 154, the load transfer device 100 of the present invention is easily removed as seen in FIG. 10. After the slip hook 119 of the load transfer device has been disconnected from the antenna 144, the load transfer device can be removed from the antenna pipe 145 and transported back to the ground.

As will be appreciated by one of skill in the art, the opposite process may be used to lower an antenna 144 or other equipment down to the ground by carrying out the steps shown in FIGS. 4-10 in reverse order. This would be desirable if more complex repairs or maintenance was required for the antenna 144 or other equipment. If the user must take down an antenna 144 or other component from the top of the tower 142, ropes, straps, and/or other means known in the art now or in the future are used to attach the antenna 144 to the slip hook 119 or other clasping device 121 that is connected to the load transfer device 100. The antenna 144 can then be removed from the tower 142, such as from the antenna mount 156 at the top of the tower 142. As the antenna 144 is detached, the load transfer device 100 of the present invention increasingly supports the weight of the antenna 144 until it totally supports the antenna 144. The rope retention device 120 may then be used to hold the pulley rope 116, and therefore the antenna 144, in place. When ready, the load transfer device 100 may be used to move the antenna 144 toward the ground using the pulley system 115, for example a 2:1 pulley, on the load transfer device 100. If desired, the weight of the component may instead be transferred to the load line 148, which is supported by the tower 142 and not only the antenna mount 156. The load line 148 can then be used to lower the antenna 144 to the ground.

Although various representative embodiments of this invention have been described above with a certain degree of particularity, those skilled in the art could make numerous alterations to the disclosed embodiments without departing from the spirit or scope of the inventive subject matter set forth in the specification and claims. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements, and/or substantial equivalents.

1. A load transfer device for appurtenances to be installed on a vertical infrastructure installation comprising:
a. An elongated member having a first end and a second end, wherein said second end of said elongated member is configured to connect to said vertical infrastructure installation,
b. A head attached to said first end of said elongated member, wherein said head comprises a housing and a first pulley wheel,
c. A pulley rope in communication with said head, wherein said pulley rope is fixed to said head on at least one end of said pulley rope,
d. a second pulley wheel in communication with said pulley rope wherein said second pulley wheel is not directly connected to said head, wherein said second pulley wheel further comprises a clasping device.

2. The load transfer device of claim 1 wherein said elongated member further comprises a collar between said first end and said second end.

3. The load transfer device of claim 2 further comprising a handle attached to said collar.

4. The load transfer device of claim 1 wherein said clasping device is a slip hook.

5. The load transfer device of claim 1, wherein said vertical infrastructure installation is a tower.

6. The load transfer device of claim 1, wherein said vertical infrastructure installation is a mast.

7. The load transfer device of claim 1, wherein said second end of said elongated member is sized such as to removably interface with an antenna pipe attached to said vertical infrastructure installation.

8. The load transfer device of claim 1 further comprising a rope retention device attached to said head, wherein said rope retention device is in communication with said pulley rope.

9. The load transfer device of claim 8 wherein said rope retention device comprises a rope grabbing mechanism and a pressure block.

10. The load transfer device of claim 9 wherein said rope retention device further comprises a pull wire configured to release said rope grabbing mechanism when pulled.

11. A method of transferring an appurtenance to a desired installation location at the top of a vertical infrastructure installation comprising:
a. Installing a load transfer device above a desired installation location, wherein said load transfer device comprises an elongated member having a first end and a second end, wherein said second end of said elongated member is configured to connect to a cell tower, a head attached to said first end of said elongated member, wherein said head comprises a housing and a first pulley wheel, a pulley rope in communication with said head, wherein said pulley rope is fixed to said head on at least one end of said pulley rope, a second pulley wheel in communication with said pulley rope wherein said second pulley wheel is not directly connected to said head, wherein said second pulley wheel further comprises a clasping device,
b. Raising said appurtenance to the height of said desired installation location using a load line connected to said vertical infrastructure installation,
c. Connecting said pulley rope of said load transfer device to said appurtenance,
d. Shifting the weight of said appurtenance from said load line to said load transfer device,
e. Disconnecting said load line from said appurtenance.

12. The method of claim 11 wherein said appurtenance comprises at least one antenna.

13. The method of claim 11 wherein said appurtenance comprises at least one transceiver.

14. The method of claim 11 wherein said appurtenance comprises at least one baseband unit.

15. The method of claim 11 wherein said appurtenance comprises at least one power source.

16. A method of removing an appurtenance from a peripheral location at the top of a vertical infrastructure installation comprising:
a. Installing a load transfer device above an installation location wherein said appurtenance is located, wherein said load transfer device comprises an elongated member having a first end and a second end, wherein said second end is configured to connect to a telecommunications structure, a head attached to said first end, wherein said head comprises a housing and a first pulley wheel, a pulley rope in communication with said head, wherein said pulley rope is fixed to said head on at least one end of said pulley rope, a second pulley wheel in communication with said pulley rope wherein said second pulley wheel is not directly connected to said head, wherein said second pulley wheel further comprises a clasping device,
b. Connecting said pulley rope from said load transfer device to said appurtenance using said clasping device,
c. Disconnecting said appurtenance from said installation location,
d. Connecting said appurtenance to a load line,
e. Shifting the weight of said appurtenance from said load transfer device to said load line,
f. Disconnecting said appurtenance from said load transfer device,
g. Lowering said appurtenance to the ground via said load line.

17. The method of claim 16 wherein said appurtenance is selected from the group of at least one antenna, at least one transceiver, at least one baseband unit, and at least one power source.

18. The method of claim 16 wherein said clasping device comprises a slip hook.
